(19) United States
(12) Patent Application Publication
(10) Pub. No.: US 2025/0078102 A1
(43) Pub. Date: Mar. 6, 2025

(54) INFORMATION PROCESSING APPARATUS, INFORMATION PROCESSING METHOD, AND NON-TRANSITORY COMPUTER-READABLE STORAGE MEDIUM

(71) Applicant: NEC Corporation, Minato-ku, Tokyo (JP)

(72) Inventors: Junpei OGAWA, Tokyo (JP); Shuhei YAMADA, Tokyo (JP); Norihito GOTO, Tokyo (JP)

(73) Assignee: NEC Corporation, Minato-ku, Tokyo (JP)

(21) Appl. No.: 18/286,296

(22) PCT Filed: Jan. 28, 2022
(86) PCT No.: PCT/JP2022/003356

§ 371 Date: Oct. 10, 2023

(30) Foreign Application Priority Data
Apr. 19, 2021 (JP) 2021-070593

(51) Int. Cl. G06Q 30/0202; G06Q 10/04

(52) U.S. Cl. CPC G06Q 30/0202; G06Q 10/04

(57) ABSTRACT

An information processing apparatus (100) includes a generation unit (102) generating an optimization model (80) by using template information (10) defining an objective function and a constraint that are indicators of an optimization problem, wherein the template information (10) includes item definition information (12) determining data items input to the objective function and the constraint, and algorithm definition information (14) defining an algorithm for the objective function and the constraint.

### TECHNICAL FIELD

The present invention relates to an information processing apparatus, an information processing method, and a program and particularly relates to an information processing apparatus, an information processing method, and a program that perform data analysis.

### BACKGROUND ART

Technologies for predicting future demand, occurrence of an abnormality, or the like by analyzing past data and generating a prediction model have been developed. For example, Patent Document 1 discloses a technology for, based on an attribute of a user making a reservation related to an area where a business operator is positioned, predicting demand for a target of business by the business operator, the target being related to the attribute of the user. Further, Patent Document 8 describes an apparatus preparing a suitable work shift.

It is not easy to apply a prediction by data analysis to a worksite. Various analysis systems are proposed (such as Patent Documents 4 to 7), and for example, there are various specific techniques for generating a prediction model. Therefore, a suitable technique needs to be selected from among the various techniques.

In this respect, Patent Document 2 discloses a technology for facilitating analysis of operation data by using a template. However, Patent Document 2 facilitates recognition of a past record by statistically analyzing past data and does not mention performing prediction. Therefore, a technology for facilitating prediction by data analysis is not disclosed.

### RELATED DOCUMENTS

### Patent Documents

Patent Document 1: Japanese Patent Application Publication No. 2019-053737
Patent Document 2: Japanese Patent Application Publication No. 2000-285128
Patent Document 3: United States Patent Application Publication No. 2014/0222741A1, Specification
Patent Document 4: International Application Publication No. WO 2014/010071
Patent Document 5: Japanese Patent Application Publication No. 2020-191114
Patent Document 6: Japanese Patent Application Publication No. 2019-160291
Patent Document 7: Japanese Patent Application Publication No. 2017-142800
Patent Document 8: Japanese Patent Application Publication No. 2012-181719

### Non-Patent Document

Non-Patent Document 1: Kenji Fukuda, “How AI Is Transforming Financial Services,” NEC Technical Journal, vol. 69, No. 2, 2016, pp. 16 to 19

### SUMMARY OF INVENTION

### Technical Problem

When such a prediction result by data analysis is applied to an actual operation, it is further desired to find a combination of variables optimizing a predetermined indicator (a solution sizing up or minimizing an objective function) from among many options under various constraints in the operation, in other words, to efficiently and effectively solve a so-called optimization problem.

The present invention has been made in view of the aforementioned circumstances, and an object of the present invention is to provide a technology for efficiently and effectively solve a complex optimization problem.

### Solution to Problem

In order to resolve the aforementioned issue, the following configurations are respectively employed in aspects of the present invention.

A first aspect relates to an information processing apparatus.

An information processing apparatus according to the first aspect includes
a generation unit that generates an optimization model by using a template defining an objective function and a constraint that are indicators of an optimization problem, wherein
the template includes item definition information determining data items input to the objective function and the constraint, and algorithm definition information defining an algorithm for the objective function and the constraint.

A second aspect relates to an information processing method executed by at least one computer.

An information processing method according to the second aspect includes, by an information processing apparatus,
generating an optimization model by using a template defining an objective function and a constraint that are indicators of an optimization problem, wherein
the template includes item definition information determining data items input to the objective function and the constraint, and algorithm definition information defining an algorithm for the objective function and the constraint.

Note that another aspect of the present invention may be a program causing at least one computer to execute the method according to the aforementioned second aspect or may be a computer-readable storage medium on which such a program is recorded. The storage medium includes a non-transitory and tangible medium.

The computer program includes a computer program code causing a computer to execute the information processing method on the information processing apparatus when being executed by the computer.

Note that any combination of the components described above, and representations of the present invention converted between a method, an apparatus, a system, a storage medium, a computer program, and the like are also valid as embodiments of the present invention.

Further, various components of the present invention do not necessarily need to be individually independent, and for example, a plurality of components may be formed as a single member, a plurality of members may form a single component, a certain component may be part of another component, and part of a certain component may overlap with part of another component.

Further, while a plurality of procedures are described in a sequential order in the method and the computer program according to the present invention, the order of description does not limit the order in which the plurality of procedures are executed. Therefore, when the method and the computer program according to the present invention are executed, the order of the plurality of procedures may be changed without affecting the contents.

Furthermore, the plurality of procedures in the method and the computer program according to the present invention are not limited to be executed at timings different from each other. Therefore, for example, a certain procedure may be executed during execution of another procedure, and an execution timing of a certain procedure and an execution timing of another procedure may overlap with each other in part or in whole.

### Advantageous Effects of Invention

Each of the aforementioned aspects enables provision of a technology for efficiently and effectively solving a complex optimization problem.

### BRIEF DESCRIPTION OF THE DRAWINGS

FIG. 1 It is a diagram illustrating an embodiment of an information processing system.

FIG. 2 It is a functional block diagram logically illustrating a configuration of an information processing apparatus according to an example embodiment.

FIG. 3 It is a block diagram illustrating a hardware configuration of a computer providing the information processing apparatus in FIG. 2.

FIG. 4 It is a flowchart illustrating an example of operation of the information processing apparatus according to the example embodiment.

FIG. 5 It is a diagram illustrating an example of an indicator list screen of an optimization template.

FIG. 6 It is a diagram illustrating an example of a data structure of template information of the template in FIG. 5.

FIG. 7 It is a functional block diagram logically illustrating a configuration of an information processing apparatus according to an example embodiment.

FIG. 8 It is a flowchart illustrating an example of operation of the information processing apparatus according to the example embodiment.

FIG. 9 It is a diagram illustrating an example of an optimization execution screen.

FIG. 10 It is a diagram illustrating an example of a parameter setting screen.

FIG. 11 It is a diagram illustrating an example of an import screen.

FIG. 12 It is a diagram illustrating an example of a data file imported in FIG. 11.

FIG. 13 It is a flowchart illustrating an example of operation of an information processing apparatus according to an example embodiment.

FIG. 14 It is a diagram illustrating another example of the optimization execution screen in FIG. 9.

FIG. 15 It is a diagram illustrating a data structure example of template information of a template for executing intention learning.

FIG. 16 It is a diagram illustrating another example of the indicator list screen in FIG. 5.

FIG. 17 It is a diagram illustrating an output example of an analysis result.

### EXAMPLE EMBODIMENT

Example embodiments of the present invention will be described below by using drawings. Note that in every drawing, similar components are given similar signs, and description thereof is not included as appropriate. Further, in each of the following diagrams, a configuration of a part not related to the essence of the present invention is not included and is not illustrated.

In the example embodiments, “acquisition” includes at least either of an apparatus getting data or information stored in another apparatus or a storage medium (active acquisition), and an apparatus inputting data or information output from another apparatus to the apparatus (passive acquisition). Examples of the active acquisition include making a request or an inquiry to another apparatus and receiving a response, and readout by accessing another apparatus or a storage medium. Further, examples of the passive acquisition include reception of distributed (or, for example, transmitted or push notified) information. Furthermore, “acquisition” may refer to selective acquisition from received data or information, or selective reception of distributed data or information.

### First Example Embodiment

### <System Overview>

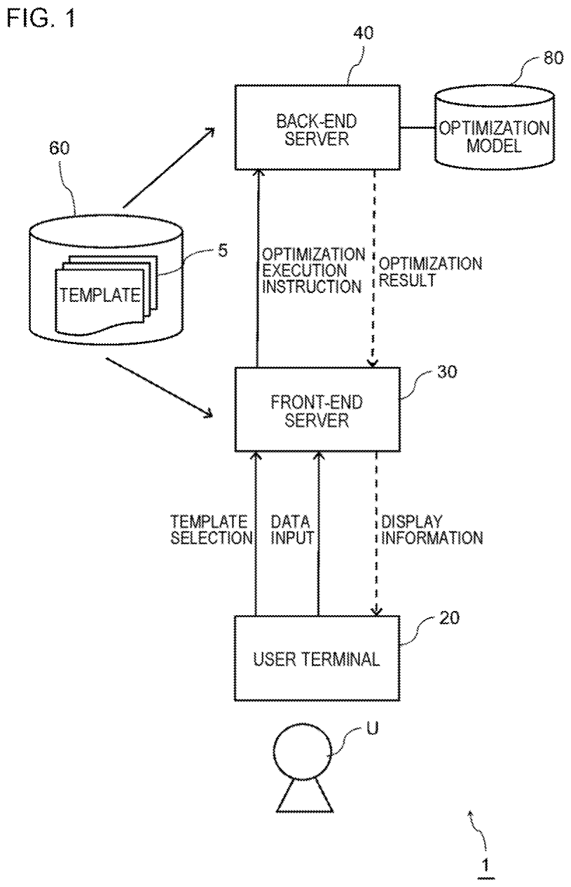

An information processing system 1 according to an example embodiment of the present invention is a system for solving various optimization problems in operations. The information processing system 1 is provided by using one or more computers. FIG. 1 is a diagram illustrating an embodiment of the information processing system 1.

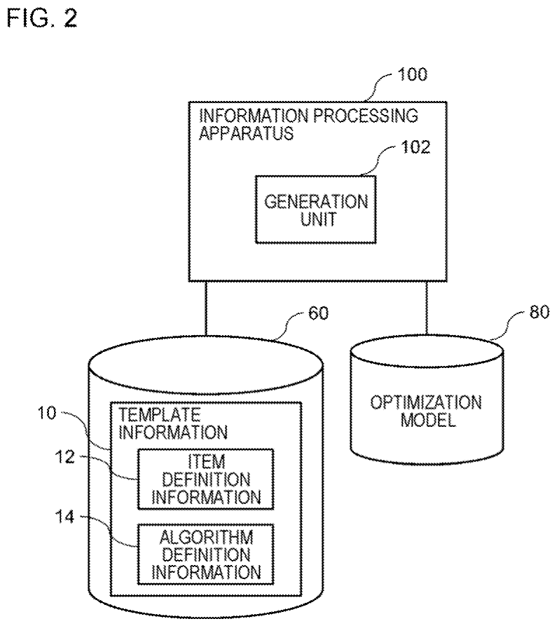

In FIG. 1, the information processing system 1 includes an information processing apparatus 100 (FIG. 2) configured with a front-end server 30 and a back-end server 40. Thus, the information processing apparatus 100 may be provided by at least two computers or may be provided by one computer.

For example, the front-end server 30 provides a user U with a website for using the information processing system 1. The user U who prefers to use the information processing system 1 first accesses the front-end server 30 by using a user terminal 20. The front-end server 30 provides the user terminal 20 with a web page for specifying template information 10 (FIG. 2) and input data. By using the provided web page on the user terminal 20, the user U performs operations such as selection of a template 5 and input of data.

For example, the user terminal 20 is provided by a computer such as a tablet terminal and includes a display apparatus (unillustrated) such as a liquid crystal display and an input apparatus (unillustrated) such as a touch panel. A web page provided to the user terminal 20 by the front-end server 30 is displayed on a screen on the display (unillustrated) on the user terminal 20, and the user U can perform input and selection by operating a graphical user interface (GUI) displayed on the screen through, for example, operating the touch panel on the user terminal 20.

As for use of a web page using the user terminal 20, for example, the web page can be used on the user terminal 20 by accessing a uniform resource locator (URL) by using an application such as a browser and logging in by using a user count in which the user U using the system is previously user registered.

The front-end server 30 causes the back-end server 40 to execute optimization by using a template 5 selected by the user U and input data. For example, the front-end server 30 causes the back-end server 40 to execute optimization by transmitting a predetermined command including information received from the user terminal 20, such as identification information of the template 5, to the back-end server 40. By executing optimization in response to the instruction, the back-end server 40 generates an optimization model 80.

While details of processing indicated by a broken arrow in FIG. 1 will be described in an example embodiment to be described later, the front-end server 30 can receive information representing the optimization result (information about the optimization model 80) from the back-end server 40, generate display information by using view definition information related to the template 5, provide the display information to the user terminal 20, and cause the user terminal 20 to display the display information.

The embodiment of the information processing system 1 is not limited to the aforementioned example. For example, the front-end server 30 and the back-end server 40 may be provided by one computer. In addition, for example, functions equivalent to those of the front-end server 30 may be imparted to the user terminal 20. Specifically, a function of accepting specification of the template information 10 and input data, a function of instructing the back-end server 40 to execute optimization, a function of receiving an optimization result from the back-end server 40, and a function of generating display information from the received optimization result are imparted to the user terminal 20 (in other words, an application for providing a function of exchanging information with the back-end server 40 is installed on the user terminal 20). In addition, for example, the functions of both the front-end server 30 and the back-end server 40 may be imparted to the user terminal 20. Specifically, the information processing system 1 may be provided by a computer operated by the user U (an application providing all the functions of the information processing system 1 is installed on the user terminal 20).

### <Functional Configuration Example>

FIG. 2 is a functional block diagram logically illustrating a configuration of the information processing apparatus 100 according to the present example embodiment. The information processing apparatus 100 includes a generation unit 102. The generation unit 102 generates an optimization model 80 by using template information 10 of a template 5 defining an objective function and a constraint that are indicators of an optimization problem.

The template information 10 includes item definition information 12 and an algorithm definition information 14. The item definition information 12 and the algorithm definition information 14 include information defined by the user U. The item definition information 12 includes information determining data items input to an objective function and a constraint. The algorithm definition information 14 includes information defining an algorithm for the objective function and the constraint.

A plurality of templates 5 each defining an objective function and a constraint that are indicators of an optimization problem are prepared for each optimization problem. A template 5 is defined by template information 10. The user U can select a template 5 to be used, depending on a content of operations, a purpose and a content of optimization to be solved, and the like. For example, a template 5 is preferably prepared for each optimization purpose, for each optimization content, for each target business category, and for each content of target operations. For example, in preparation of a work shift, the user U may be able to select a template 5 with a business category of an optimization target such as whether to target a manufacturing plant or whether to target a retail store such as a convenience store, the number of shift allocations, the type of a content of operations, or the like, as a basis for consideration in selection. Note that a template 5 dedicated to a business category or a content of operations may be prepared for each user U.

Furthermore, a plurality of objective functions and a plurality of constraints that are indicators of an optimization problem are prepared. The user U can specify an objective function and a constraint to be used for execution of optimization from among the objective functions and the constraints. Furthermore, a parameter part that can be changed by the user U is provided in each indicator of an optimization problem and can be specified in such a way as to match an actual operation. Thus, a template 5 can be customized to a work content, a purpose and a content of optimization, a condition to which importance is attached, and the like.

Constraints of an optimization problem include an essential condition that always needs to be satisfied (hereinafter also referred to as a hard constraint) and an optional condition that is preferably satisfied (hereinafter also referred to as a soft constraint). In template information 10, a soft constraint is incorporated as an element of an objective function, and a hard constraint is incorporated as a constraint.

### <Hardware Configuration Example>

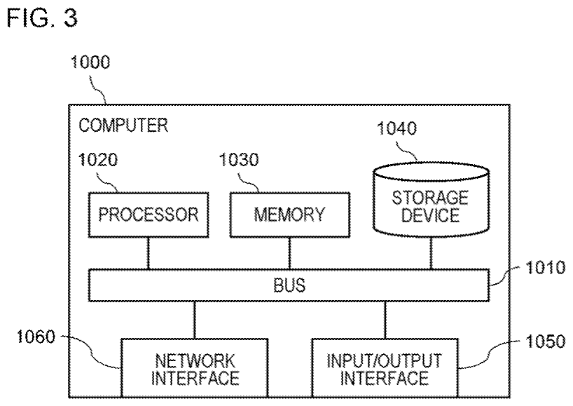

FIG. 3 is a block diagram illustrating a hardware configuration of a computer 1000 providing the information processing apparatus 100 (FIG. 2) described above. The information processing apparatus 100 according to the present example embodiment is provided by the end server 30 and the back-end server 40 in FIG. 1, each server being provided by the computer 1000. Further, the user terminal 20 in FIG. 1 is also provided by the computer 1000.

Each functional unit in the information processing apparatus 100 may be provided by hardware (such as a hard-wired electronic circuit) providing the functional unit or by a combination of hardware and software (such as a combination of an electronic circuit and a program controlling the circuit). The case of each functional unit in the information processing apparatus 100 being provided by a combination of hardware and software will be further described below.

The information processing apparatus 100 is provided by using one or more computers. FIG. 3 is a diagram illustrating the computer 1000 for providing the information processing apparatus 100. The computer 1000 may be any computer. For example, the computer 1000 is a stationary computer such as a personal computer (PC) or a server machine. In addition, for example, the computer 1000 is a portable computer such as a smartphone, a tablet terminal, or a notebook PC.

The computer 1000 may be a dedicated computer designed for providing the information processing apparatus 100 or a general-purpose computer. In the latter case, for example, the computer 1000 provides at least part of the functions of the information processing apparatus 100 by installing a predetermined application on the computer 1000. The aforementioned application is an application configured with a program for providing one or more functional units in the information processing apparatus 100.

For example, as will be described later, the information processing apparatus 100 may be configured with the back-end server 40 generating an optimization model and the front-end server 30 functioning as an interface between the user terminal 20 and the back-end server 40 (see FIG. 1). In this case, the front-end server 30 and the back-end server 40 are provided by computers 1000 different from each other. In this case, an application for providing a function imparted to the front-end server 30 out of the functions of the information processing apparatus 100 is installed on the computer 1000 providing the front-end server 30. On the other hand, an application for providing a function imparted to the back-end server 40 out of the functions of the information processing apparatus 100 is installed on the computer 1000 providing the back-end server 40.

The computer 1000 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from each other. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a hard disk drive (HDD), a solid-state drive (SSD), a memory card, a read-only memory (ROM), or the like. The storage device 1040 stores program modules providing the functions of the information processing apparatus 100 (such as the generation unit 102 and an acceptance unit 104 to be described later). By reading each program module into the memory 1030 and executing the program module by the processor 1020, each function related to the program module is provided. Further, the storage device 1040 may store various pieces of data in a template information storage apparatus 60 (such as template information 10), input data, and various pieces of data such as a generated optimization model 80.

The program modules may be recorded on a storage medium. The storage medium on which the program module is recorded includes a non-transitory and tangible medium usable by the computer 1000, and a program code readable by the computer 1000 (the processor 1020) may be embedded in the medium.

The input-output interface 1050 is an interface for connecting the computer 1000 to various types of input/output equipment. The input-output interface 1050 also functions as a communication interface performing short-distance wireless communication such as Bluetooth (registered trademark) and near-field communication (NFC).

The network interface 1060 is an interface for connecting the computer 1000 to a communication network. Examples of the communication network include a local area network (LAN) and a wide area network (WAN). The method for connecting the network interface 1060 to the communication network may be a wireless connection or a wired connection.

Then, the computer 1000 is connected to required equipment [such as the front-end server 30, the back-end server 40, and a display, a touch panel, a keyboard, a mouse, an operation switch, a speaker, a microphone, a camera, and a printer (all of which are unillustrated) in the user terminal 20] through the input-output interface 1050 or the network interface 1060.

### <Operation Example>

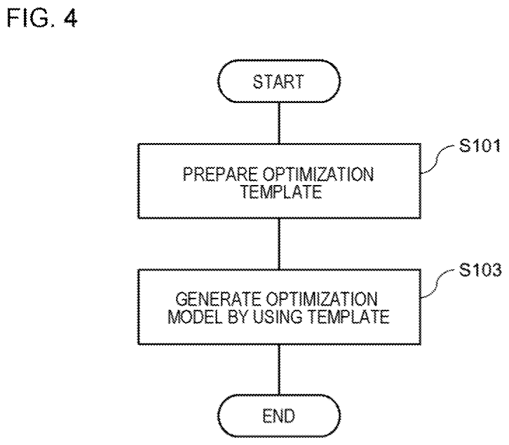

FIG. 4 is a flowchart illustrating an example of operation of the information processing apparatus 100 according to the present example embodiment. First, an optimization template 5 is prepared (Step S101). Preparation of a template 5 includes selecting indicators used for optimization, accepting and saving a parameter setting (change), and the like. A template 5 for which indicators are selected and parameters are set is stored in the template information storage apparatus 60. Details of the parameter setting processing will be described in an example embodiment to be described later. It is assumed in the present example embodiment that a template 5 for which parameters are already set is used.

Then, the generation unit 102 generates an optimization model 80 by using the template 5 (Step S103).

Thus, the generation unit 102 generates an optimization model 80 by optimizing input data and outputs information about the generated optimization model 80. A method for generating an optimization model 80 and a form in which information about a generated optimization model 80 is output are previously determined as a template 5. Information representing the template 5 is hereinafter referred to as template information 10.

As described above, the template information 10 includes the item definition information 12 and the algorithm definition information 14. The item definition information 12 is information determining an item of each piece of input data used for generation of an optimization model 80. For example, it is assumed that information about a past shift record and a future shift preference of each employee and information about an attribute such as work that can be handled by each employee are used in generation of an optimization model 80 for optimizing a shift in a part-time job. In this case, the item definition information 12 in template information 10 for generating the optimization model 80 includes an item corresponding to “information about a shift record of an employee” (such as “work shift record”), an item corresponding to “information about a vacation/work preference of an employee” (such as “vacation/work preference”), an item corresponding to “information about an attribute of an employee” (such as “employee attribute”), and the like.

The algorithm definition information 14 determines an algorithm for generating an optimization model 80. For example, it is assumed that a plurality of types of AI engines are prepared as program modules being a tangible form of algorithms for generating an optimization model 80. In this case, the algorithm definition information 14 indicates information determining one AI engine (identification information of the AI engine) out of the plurality of types of AI engines. Note that the algorithm definition information 14 may include an AI engine itself instead of identification information of the AI engine. Further, a tangible form of an algorithm used for generation of an optimization model 80 is not limited to an AI engine.

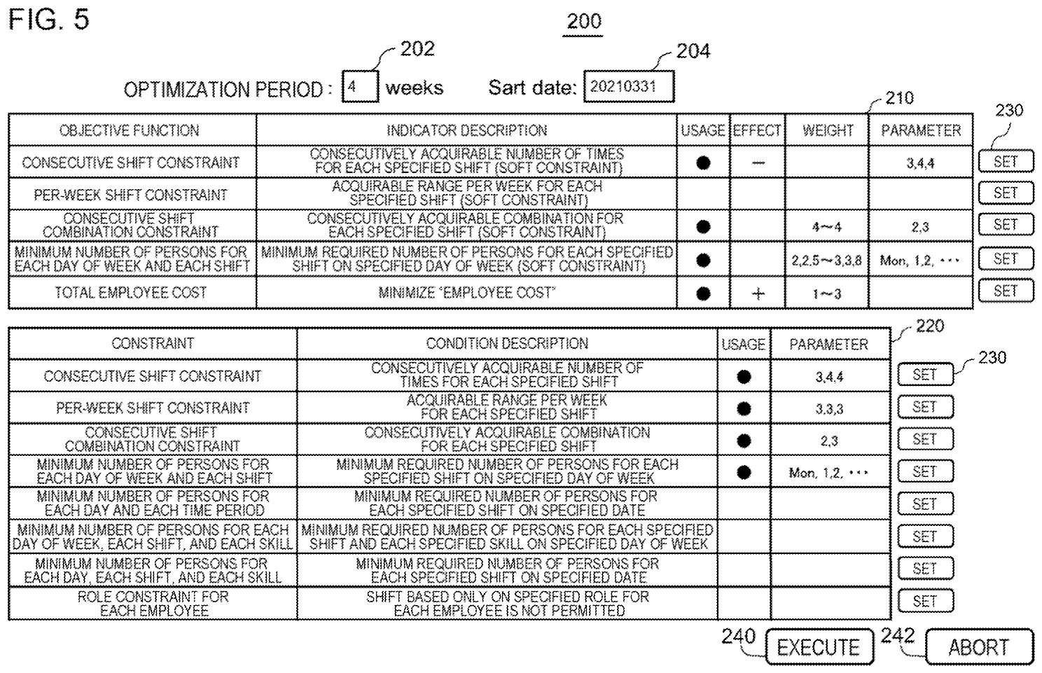

FIG. 5 is a diagram illustrating an example of an indicator list screen 200 for a certain optimization template 5. The indicator list screen 200 includes an objective function list 210, a constraint list 220, an execution button 240, and an abort button 242. The objective function list 210 includes a plurality of objective functions, and each objective function is provided for each item to be optimized, that is, each indicator of an optimization problem to be solved. Furthermore, the constraint list 220 includes a plurality of constraints and each constraint is provided for each item to be optimized, that is, each indicator of an optimization problem to be solved. Examples of an item to be optimized include an operating cost such as an employee allowance, total working hours of all employees, an attendance preference achievement rate of employees, a customer satisfaction expectation value, and an expected number of customers in a case of a retail store.

A group of a plurality of indicators in the template 5 is provided for each purpose of optimization. Examples of a purpose of optimization (optimization problem) include optimization of a work shift at a manufacturing plant or a retail store and optimization of matching between an attribute of required personnel and a required talent in a process in the schedule.

The objective function list 210 includes an objective function name field, an indicator description field, a usage field indicating usage status of the objective function, an effect field, a weight field, and a parameter field. The constraint list 220 includes a constraint name field, a condition description field, a usage field, and a parameter field. Details of each field will be described in an example embodiment to be described later.

Furthermore, a setting button 230 is provided for each row in the objective function list 210 and the constraint list 220, and a parameter, a weight, or the like of each indicator can be set by accepting depression of the setting button 230. Details of setting of a parameter and a weight will also be described in an example embodiment to be described later. Further, “●” is displayed in a usage field in the objective function list 210 and the constraint list 220 for an indicator selected for use by the user U. For example, by performing a selection operation on a usage field in a row for each indicator in the objective function list 210 and the constraint list 220, usage status of the indicator may be specified.

FIG. 5 illustrates an example of an indicator list screen 200 for an optimization template 5 for a work shift of a part-time job at a certain store. Then, a consecutive shift constraint, a consecutive shift combination, a minimum number of persons for each day of week and each shift, and an employee cost are selected for use as objective functions, and a consecutive shift constraint, a per-week shift constraint, a consecutive shift combination constraint, and a minimum number of persons for each day of week and each shift are selected for use as constraints. In addition, a minimum number of items, a minimum number of products, a maximum product cost, and a product item combination constraint are listed as objective functions in a case of a shelf space allocation optimization problem for products. It is assumed in the present example embodiment that objective functions and constraints to be used are in a previously selected state, and parameters of each indicator are also in a preset state.

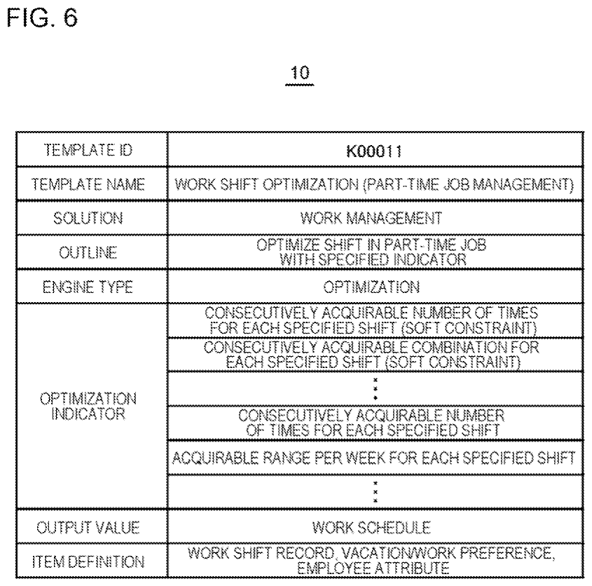

FIG. 6 is a diagram illustrating an example of a data structure of template information 10 of the template 5 in FIG. 5. An optimization AI engine is specified as an engine type. Optimization indicators include objective functions and constraints that can be specified in FIG. 5 and correspond to the algorithm definition information 14. An output value is information about an output value output as an optimization result. A work schedule is output in this case, and specification of a start date of the schedule and a schedule period, and layout information of an output data file may also be included. Item definition indicates input data items and corresponds to the item definition information 12.

Thus, the template information 10 further includes view definition information 16 for determining a display form of information about an analysis result by the optimization model 80. For example, the view definition information 16 includes a type and a structure of a chart used for representing information about the optimization model 80, a placement of a plurality of charts, or the like.

Display information about an optimization model 80 generated by the generation unit 102 is generated in a display form defined by the view definition information 16 in the template information 10. For example, information about an optimization model 80 is displayed by using a diagram which is easy to recognize visually. Then, the view definition information 16 includes definitions of a type, a structure, and the like of each of one or more diagrams included in the display information. Any type such as a table, a scatter diagram, a line graph, or a bar graph may be employed as a type of a diagram. For example, a definition of each column is included in a structure of a table. For example, a definition of each axis is included in a structure of a graph. The view definition information 16 further includes information determining an overall placement of a plurality of diagrams and other information.

The front-end server 30 described above can generate display information by processing an optimization model 80 by using view definition information 16. The front-end server 30 outputs the display information to the user terminal 20. For example, the display information is a web page allowing information about the optimization model 80 to be browsed in a display form defined by the view definition information 16 in the template information 10. In addition, for example, the display information may be provided as a file such as a PDF file.

Returning to FIG. 5, the indicator list screen 200 further includes an optimization period weeks specification field 202 and an optimization period start date specification field 204. The optimization period weeks specification field 202 is a textbox for accepting specification of the number of weeks in a period in which optimization is to be performed, and the optimization period start date specification field 204 is a textbox for accepting specification of a start date of the period in which optimization is to be performed. Note that specification of a finish date of a differentiation execution period may be accepted instead of specification of the number of weeks.

When the execution button 240 is depressed by the user U, the generation unit 102 generates an optimization model 80 in a period specified by an optimization period by using an indicator previously selected for use in the template information 10 (FIG. 6) and a parameter preset to the indicator, in response to the depression. Specifically, an optimized work shift schedule of a part-time job in a specified optimization period is generated in this example. On the other hand, when the abort button 242 is depressed by the user U, the generation unit 102 stops optimization and closes the indicator list screen 200, in response to the depression.

As described above, according to the present example embodiment, the generation unit 102 generates an optimization model 80 by using a template 5 defining an objective function and a constraint that are indicators of an optimization problem and therefore can generate an optimization model 80 by using a template 5 dedicated to an operation by defining indicators by the user U. Thus, an optimization model 80 efficiently and effectively solving a complex optimization problem can be generated.

### Second Example Embodiment

### <Functional Configuration Example>

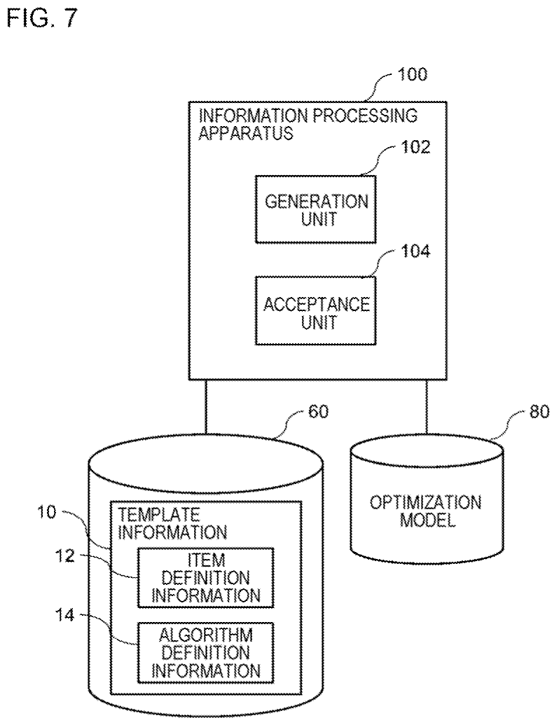

FIG. 7 is a functional block diagram logically illustrating a configuration of an information processing apparatus 100 according to the present example embodiment. The information processing apparatus 100 in FIG. 7 includes a generation unit 102 being the same as that in the information processing apparatus 100 in FIG. 2 and further includes an acceptance unit 104. The information processing apparatus 100 according to the present example embodiment is the same as the information processing apparatus 100 in FIG. 2 except for being configured to further accept specification of a parameter for changing at least part of indicators of an optimization problem and generate an optimization model 80 by using the parameter. Further, the information processing apparatus 100 according to the present example embodiment may be combined with at least one of configurations according to other example embodiments without contradicting each other.

The acceptance unit 104 accepts specification of a parameter for changing at least part of indicators of an optimization problem. The generation unit 102 generates an optimization model 80 by using a template 5 being changed by using the accepted parameter.

### <Operation Example: Parameter Setting>

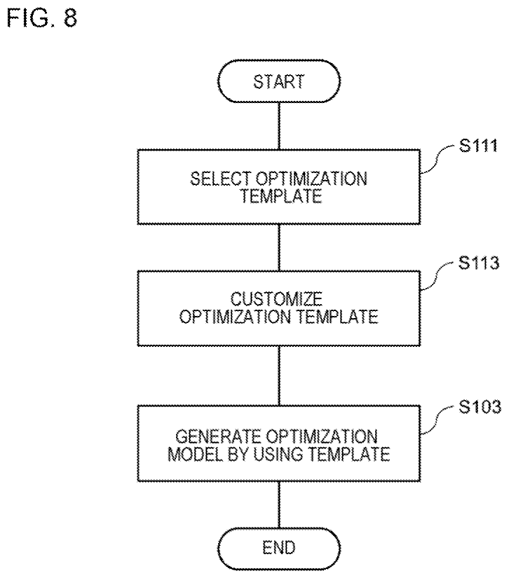

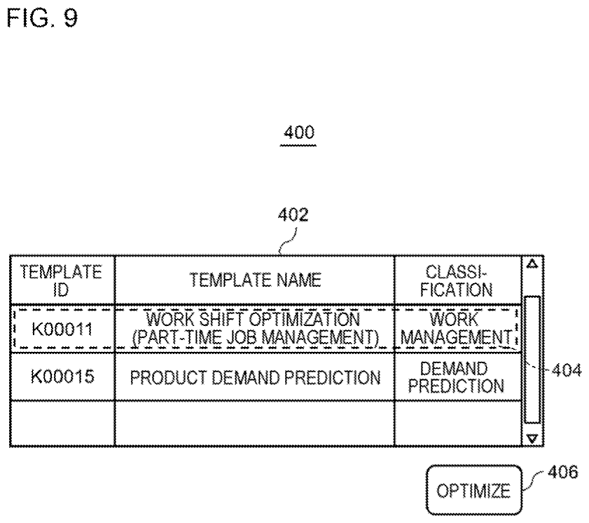

FIG. 8 is a flowchart illustrating an example of operation of the information processing apparatus 100 according to the present example embodiment. The flowchart in FIG. 8 includes Step S111 and Step S113 in place of Step S101 in the flowchart in FIG. 4. FIG. 9 is a diagram illustrating an example of an optimization execution screen 400. First, when executing optimization on a user terminal 20, a user U causes the user terminal 20 to display the optimization execution screen 400 and selects an optimization template 5 (Step S111 in FIG. 8).

The optimization execution screen 400 in FIG. 9 includes a template list 402 and an optimization execution button 406. For each template 5, the template list 402 includes identification information of the template 5 (template ID), the name of the template 5 (template name), the classification of the template 5, and the like. When a template 5 is selected by the user U (for example, when the relevant row is clicked in a mouse-over state), the relevant row 404 is, for example, displayed in reverse in response to the selection.

When depression of the optimization execution button 406 is accepted, the generation unit 102 displays an indicator list screen 200 (FIG. 5) for the selected template 5. The acceptance unit 104 accepts selection of an indicator to be used specified by the user U and a parameter set by the user U from among a plurality of indicators (objective functions and constraints) displayed on the indicator list screen 200 (Step S113).

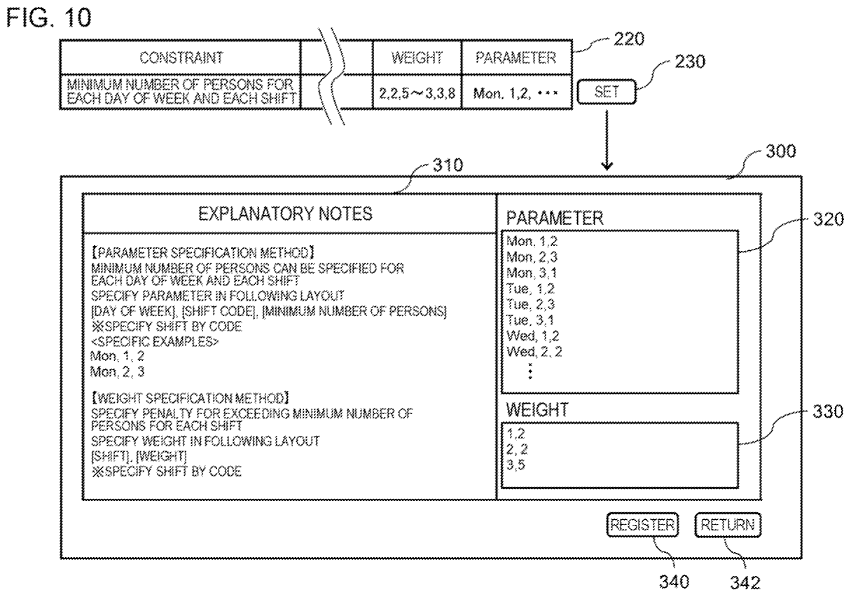

Specifically, when accepting depression of a setting button 230 in each row of an objective function list 210 and a constraint list 220 on the indicator list screen 200 in FIG. 5, the acceptance unit 104 displays a parameter setting screen 300 for indicators in FIG. 10. This example illustrates an example of the setting button 230 for a constraint on a minimum number of persons for each day of week and each shift in the constraint list 220 being depressed and a parameter setting screen 300 being displayed.

In the following description, various types of screens are displayed on a display of the user terminal 20 by a front-end server 30. Then, the front-end server 30 (the acceptance unit 104) accepts an operation of a GUI displayed on the screen by the user U and transfers an input such as accepted data or an accepted instruction to a back-end server 40.

The parameter setting screen 300 includes a specification method description field 310, a parameter specification field 320, and a weight specification field 330. The parameter setting screen 300 further includes a registration button 340 and a return button 342. The specification method description field 310 describes a method for specifying a parameter for changing at least part of indicators. The parameter specification field 320 allows input by entry into a plurality of rows in a text format. A parameter can be specified in accordance with the specification method in the specification method description field 310. Since the indicator is a constraint on a minimum number of persons for each day of week and each shift, a minimum number of required personnel on a per day-of-week basis and on a per-shift basis, such as a morning shift, an afternoon shift, and a night shift, can be specified as a parameter for each row in the parameter specification field 320. Codes indicating shifts include 1 for the morning shift, 2 for the afternoon shift, and 3 for the night shift.

In the example in this diagram, a minimum of two persons for the morning shift on Monday, a minimum of three persons for the afternoon shift on Monday, a minimum of one person for the night shift on Monday, and a minimum of two persons for the morning shift on Tuesday are specified in first to fourth rows.

While a “weight” is further specified as one of parameters for changing an indicator in the example in this diagram, setting of a “weight” will be described in an example embodiment to be described later.

When the acceptance unit 104 accepts depression of the registration button 340 by the user U after parameter entry into the parameter specification field 320 and the weight specification field 330 is finished, the generation unit 102 parameters are set based on the content entered into each field, and template information 10 in the template 5 is updated. When the acceptance unit 104 accepts depression of the return button 342 by the user U, the parameter setting screen 300 is closed and the screen returns to the indicator list screen 200. When parameter change is performed and the registration button 340 is depressed on the parameter setting screen 300, the changed parameter is displayed in the objective function list 210 and the constraint list 220 when the screen returns to the indicator list screen 200.

Then, the generation unit 102 generates an optimization model 80 by using the changed template 5 (Step S103 in FIG. 8).

Thus, according to the present example embodiment, the acceptance unit 104 accepts specification of a parameter for changing at least part of indicators of an optimization problem, and the generation unit 102 generates an optimization model 80 by using a template 5 changed by using the accepted parameter. The configuration enables parameter change according to a content of operations by specifying a parameter and an indicator of an optimization problem, and generation of an optimization model 80 by using the changed parameter. Accordingly, a complex optimization problem can be efficiently and effectively solved according to a content of operations.

### Third Example Embodiment

### <Functional Configuration Example>

An information processing apparatus 100 according to the present example embodiment includes a generation unit 102 and an acceptance unit 104 that are similar to those in the information processing apparatus 100 in FIG. 7. The information processing apparatus 100 according to the present example embodiment differs from the information processing apparatus 100 in FIG. 7 in being configured to, by the generation unit 102, generating an optimization model 80 by performing optimization by using an indicator specified by accepting an input of data defined by item definition information 12. Further, the information processing apparatus 100 according to the present example embodiment may be combined with at least one of configurations according to other example embodiments without contradicting each other. For example, the information processing apparatus 100 may be combined with the information processing apparatus 100 in FIG. 2. In that case, the acceptance unit 104 is not included, and therefore the generation unit 102 performs optimization by using a template in which indicators of an optimization problem are previously specified.

The generation unit 102 inputs data of a data item defined by item definition information 12 and, by using a template 5, optimizes the input data and generates an optimization model 80.

### <Operation Example: Data Import>

First, when executing optimization, the user U causes the user terminal 20 to display the optimization execution screen 400 in FIG. 9. Then, the generation unit 102 accepts a template ID of a template 5 selected on the template list 402. Then, in response to depression of the optimization execution button 406, the generation unit 102 imports data required for optimization using the selected template 5.

The generation unit 102 accepts specification of a data file including data of a data item defined by item definition information 12 in the selected template 5 and inputs the data from the data file. Specifically, a data file to be imported is specified on the import screen 500 as follows.

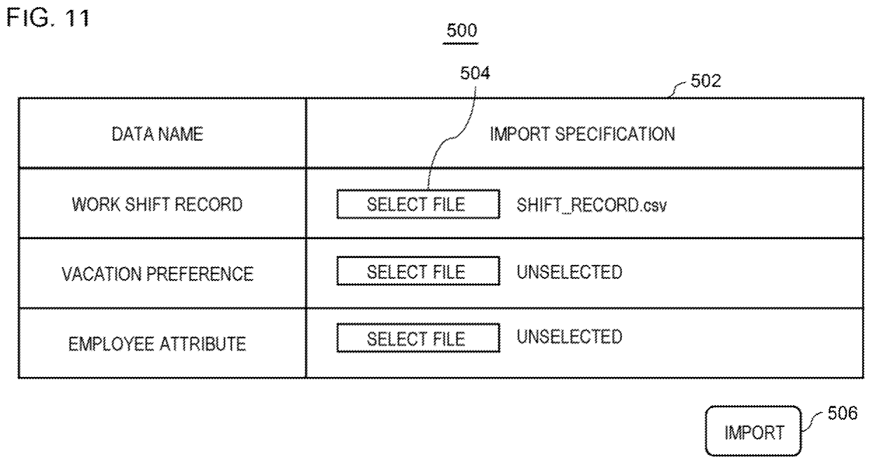

FIG. 11 is a diagram illustrating an example of an import screen 500. For example, when depression of an optimization execution button 406 on an optimization execution screen 400 in FIG. 9 is accepted, the import screen 500 is displayed. Note that a data file in which a data item required for optimization is stored may be previously specified, and the import screen 500 may not be displayed in that case. For example, a data item in item definition information 12 may be previously associated with a data file in which specified data are stored.

The import screen 500 includes a file specification list 502 and an import execution button 506. The file specification list 502 includes information about a data item (such as a data name) required for optimization and a file selection button 504 for the user U to finalize a save location of a file of the data. Further, an operation button (unillustrated) allowing reference to a layout of a required data item may be included. Reference to a layout of a required data item allows preparation and specification of a data file including the required data item.

For example, a data file is a comma separated values (CSV) file. Note that a data file format may be another format such as a text file described in the Extensible Markup Language (XML), a tab-separated values (TSV) file, an Excel (registered trademark) file, or a Symbolic Link (SYLK) file but is not limited thereto.

Further, a checkbox allowing specification of a data item to be specified in the first row of a data file may be further included for each piece of data (for each row) in the file specification list 502. A plurality of data files may be specified, and a file addition button (unillustrated) may be further included for each piece of data (for each row).

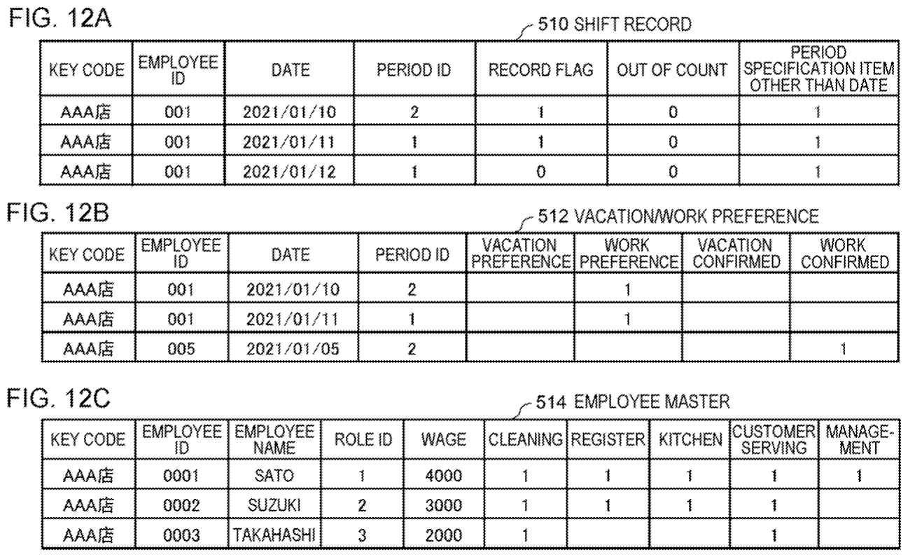

FIG. 12 is a diagram illustrating an example of a data file imported in FIG. 11. Examples of a data file imported when an optimization template 5 for work shift optimization (part-time job management) is selected include shift record data 510 (FIG. 12(a)), vacation/work preference data 512 (FIG. 12(b)), and an employee master 514 (FIG. 12(c)).

Then, when import of a data file is finished on the import screen 500, an indicator list screen 200 in FIG. 5 is displayed.

When depression of an execution button 240 on the indicator list screen 200 is accepted, the generation unit 102 optimizes the imported data by using indicators (objective functions and constraints) of an optimization problem specified by the template 5 and generates an optimization model 80.

The generation unit 102 according to the present example embodiment inputs data of a data item defined by item definition information 12 and generates an optimization model 80 by optimizing the input data by using a template 5. The configuration enables generation of an optimization model 80 by prompting the user U to specify and import data required for optimization in accordance with the item definition information 12 and algorithm definition information 14 in the template 5. Accordingly, a complex optimization problem can be efficiently and effectively solved according to a content of operations.

### Fourth Example Embodiment

An information processing apparatus 100 according to the present example embodiment includes a generation unit 102 and an acceptance unit 104 that are the same as those in the information processing apparatus 100 in FIG. 7 and therefore will be described by using FIG. 7. The information processing apparatus 100 according to the present example embodiment differs from any of the information processing apparatuses 100 described above in that the generation unit 102 derives a “weight” indicating an intention of a user by intention learning by using a past record and changes an indicator of an optimization problem by using the “weight.” Further, the information processing apparatus 100 according to the present example embodiment may be combined with at least one of configurations according to other example embodiments without contradicting each other.

Template information 10 includes a weight indicating an intention of a user U for each indicator of an optimization problem. The user U refers to a store manager of a store, a manager at a workplace, an expert, or the like. A “weight” is derived by intention learning being learning of an intention of the user U, by using a past record. Algorithm definition information 14 includes an intention learning algorithm for estimating the weight. The generation unit 102 computes a weight by using the intention learning algorithm. The generation unit 102 reflects the computed weight in the template information 10 and generates an optimization model 80.

As described above, a weight indicates an intention of a store manager or the like, and therefore, for example, reproduction and optimization of a matter on which a store manager places importance is enabled.

In the example of the parameter setting screen 300 in FIG. 10, a “weight” indicating a penalty for exceeding a minimum number of persons can be specified for each shift. A “weight” is a penalty in this example but is not limited thereto. In another example, a “weight” may be an evaluation, a level, or a point instead of a penalty. A “weight” is an indicator indicating importance of an indicator and may indicate a degree of importance placed by a store manager or the like in a case of a store or a degree of importance for an indicator being important during a specific period such as a campaign.

In this example, numerical values from 1 to 5 are specified, and a greater numerical value means a heavier penalty to be imposed. The specification method description field 310 describes a method for specifying a weight. A weight can also be input by entry into a plurality of rows in a text format. A weight is specified in one row for each shift. In the example in this diagram, the weight of a morning shift (shift code 1) is specified as 2, the weight of an afternoon shift (shift code 2) is specified as 2, and the weight of a night shift (shift code 3) is specified as 5.

The generation unit 102 according to the present example embodiment can further change the specification of a weight by intention learning.

### <Operation Example: Intention Learning>

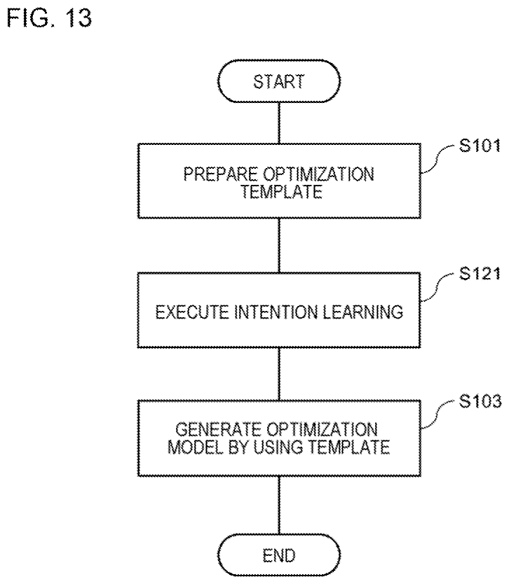

FIG. 13 is a flowchart illustrating an example of operation of the information processing apparatus 100 according to the present example embodiment. The flowchart in FIG. 13 includes Step S101 and Step S103 that are the same as those in FIG. 4 and includes Step S121 between Step S101 and Step S103. Note that Step S101 in the flowchart in FIG. 13 may be replaced by Step S111 and Step S113 in FIG. 8.

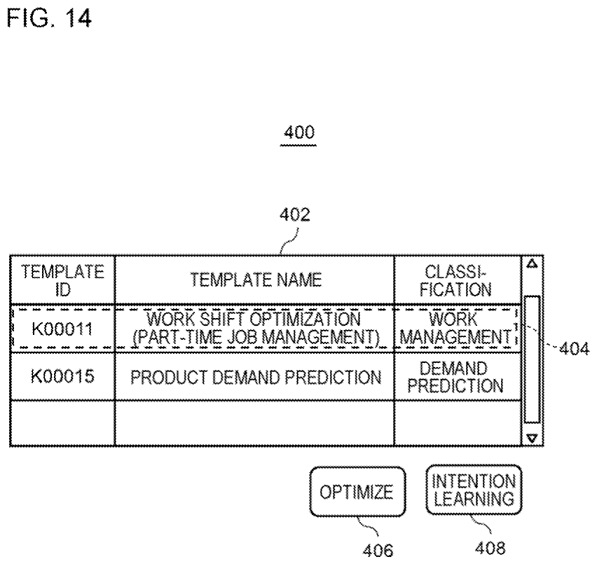

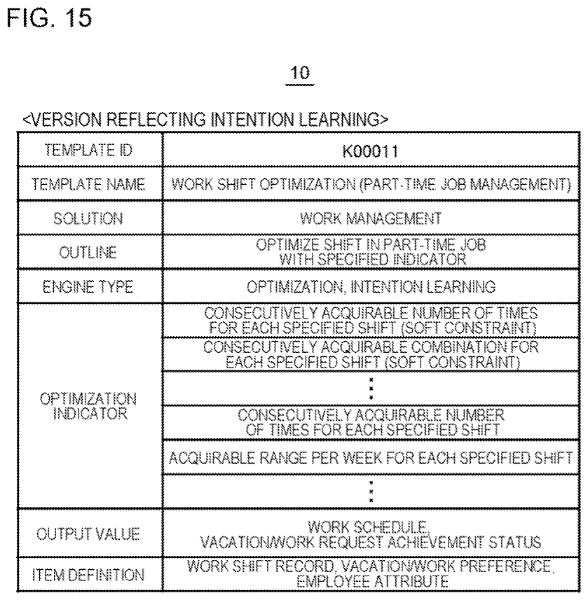

FIG. 14 is a diagram illustrating another example of the optimization execution screen 400 in FIG. 9. The optimization execution screen 400 further includes an intention learning execution button 408. When depression of the intention learning execution button 408 is accepted in a state of a template 5 being selected on the optimization execution screen 400, the generation unit 102 computes a weight by intention learning and reflects the weight in a weight in the template 5 (Step S121 in FIG. 13). FIG. 15 is a diagram illustrating a data structure example of template information 10 of a template 5 for executing intention learning. In addition to the data structure of the template information 10 in FIG. 6, an intention learning AI engine is added as a learning engine. Furthermore, vacation/work request achievement status is added as an output value as an intention learning result.

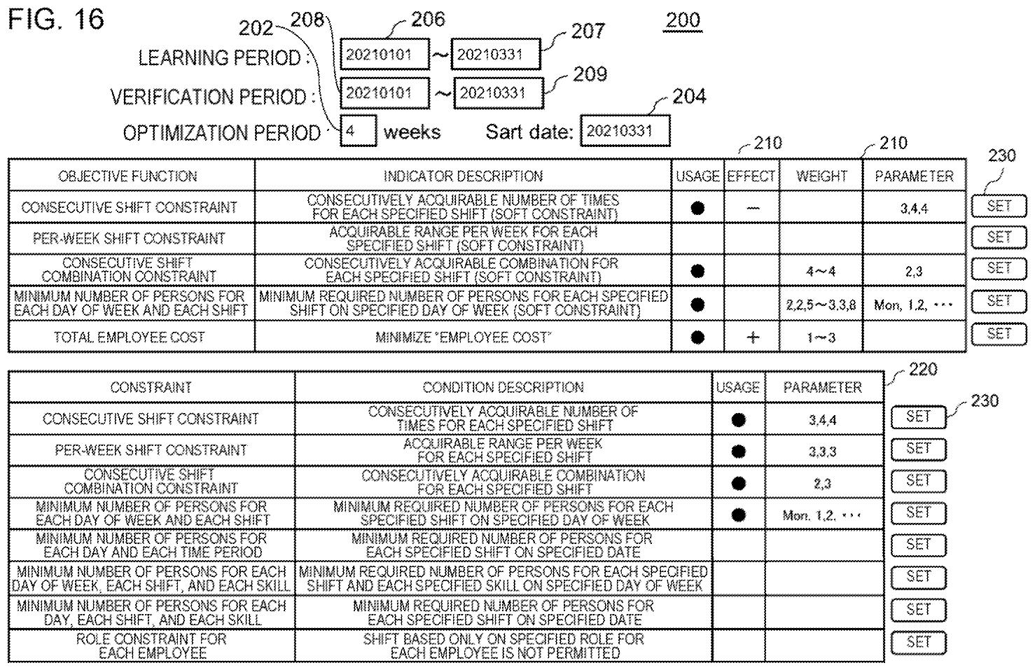

FIG. 16 is a diagram illustrating another example of an indicator list screen 200. In addition to the indicator list screen 200 in FIG. 5, FIG. 16 further includes a learning period start date specification field 206, a learning period finish date specification field 207, a verification period start date specification field 208, and a verification period finish date specification field 209.

Intention learning is performed in a learning period specified by the fields. Further, a verification period refers to a period in which optimization is performed after a weight undergoing intention learning is manually adjusted by the user U. Then, the generation unit 102 generates an optimization model 80 by using a template 5 in which an intention of the user U is reflected by intention learning (Step S103 in FIG. 13).

As a result of intention learning, an optimization model 80 includes, for each indicator of an optimization problem, weights computed by the intention learning, and the average value and the standard deviation value thereof. The optimization model 80 further includes the average value and the standard deviation value for each indicator of the optimization problem as a result of solving the optimization problem using the weights computed by the intention learning. The optimization model 80 may further include an evaluation result (such as OK or NG) for an evaluation criterion previously specified in relation to a result of the optimization problem for each indicator.

The user U may further manually adjust a weight computed by intention learning, and the optimization model 80 may, for each indicator, include a simulation result of solving the optimization problem by using the adjusted weight.

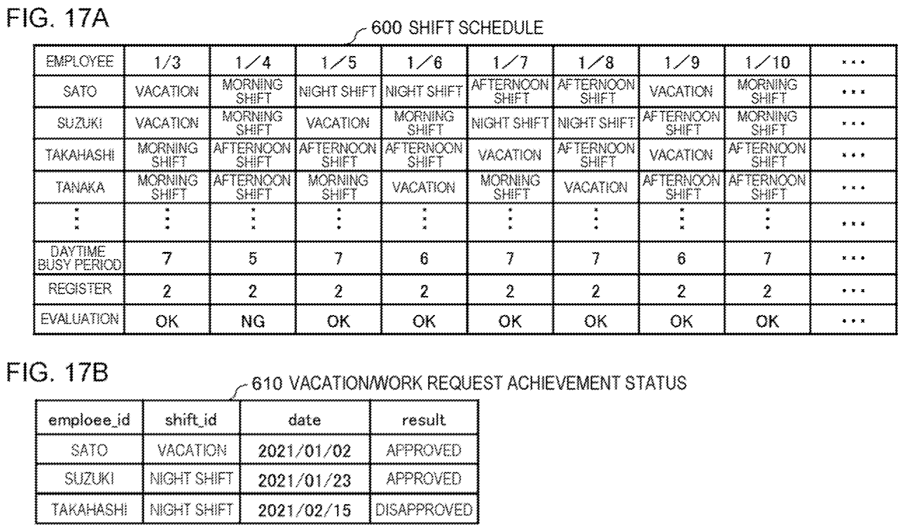

FIG. 17 is a diagram illustrating an output example of an analysis result. FIG. 17(a) illustrates a shift schedule 600, and FIG. 17(b) illustrates vacation/work request achievement status 610. The shift schedule 600 includes a daily indicator value of a shift (the number of personnel in a daytime busy period and the number of persons who can handle the register) and an evaluation result (such as OK or NG) of whether the indicator value satisfies an evaluation criterion. For example, the evaluation criterion is an essential constraint.

The shift schedule 600 in FIG. 17(a) may be drilled down on a per-person basis or on a daily basis. For example, an attribute of an employee in a shift may be referred to on a daily basis.

The vacation/work request achievement status 610 in FIG. 17(b) displays achievement status of preference on vacation/work (approved or disapproved in this case) on a per-person basis.

Thus, the generation unit 102 according to the present example embodiment generates an optimization model 80 by using a weight computed by intention learning. The configuration enables generation of an optimization model 80 with an indicator of an optimization problem being an indicator reflecting an intention of the user U such as a store manager, that is, an indicator on which the user U places importance. Accordingly, a complex optimization problem can be efficiently and effectively solved according to a content of operations and the intention of the user U.

### Fifth Example Embodiment

An information processing apparatus 100 according to the present example embodiment includes a generation unit 102 and an acceptance unit 104 that are the same as those in the information processing apparatus 100 in FIG. 7 and therefore will be described by using FIG. 7. The information processing apparatus 100 according to the present example embodiment differs from any of the information processing apparatuses 100 described above in that the generation unit 102 uses a prediction result by a prediction model as one of input data items of an optimization model 80. Further, the information processing apparatus 100 according to the present example embodiment may be combined with at least one of configurations according to other example embodiments without contradicting each other.

The generation unit 102 uses a prediction result by a prediction model as one of input data items of an optimization model 80.

A prediction model is generated by performing various prediction analyses related to operations by processing input data in accordance with various algorithms. Examples of a prediction model generation algorithm that can be handled include various machine learning algorithms such as heterogeneous mixture learning (Patent Document 3), RAPID time series analysis (Non-Patent Document 1), a neural network, and a support vector machine (SVM).

For example, for each of various machine learning algorithms, an AI engine being a program module providing the algorithm is provided. A prediction model may also be generated by using a template 5 similar to the template 5 used in generation of an optimization model 80 according to the present example embodiment. In this case, for example, algorithm definition information 14 includes identification information determining one of the plurality of AI engines. A prediction model is generated by using the AI engine determined by the identification information included in the algorithm definition information 14.

The same AI engine may be used in a plurality of analysis types (such as regression and discrimination). In this case, the algorithm definition information 14 further includes information indicating a type of analysis to be performed (a type of prediction model to be generated). For example, in template information 10 for generating, by heterogeneous mixture learning, a prediction model predicting sales of a product, the information is “AI engine: heterogeneous mixture learning, analysis type: regression.” On the other hand, in template information 10 for generating, by heterogeneous mixture learning, a prediction model predicting whether equipment fails in the future, the information is “AI engine: heterogeneous mixture learning, analysis type: discrimination.”

Further, the algorithm definition information 14 also includes information representing association between an objective variable and an explanatory variable of an AI engine, and input data. For example, which of sub-items determined in item definition information 12 should be used as the objective variable and which of the sub-items should be used as the explanatory variable are determined by the algorithm definition information 14. Note that each of the objective variable and the explanatory variable has only to be somewhat related to one or more sub-items determined by the item definition information 12 and do not need to completely match a sub-item. For example, in prediction of unit sales of a product, unit sales of the product may be included in sales record data (“unit sales” may be included in a sub-item related to a main item being sales record data), and the objective variable may be “the difference between unit sales and the moving average.”

Further, a hyper parameter to be set to an AI engine may be further determined by the algorithm definition information 14. Examples of a hyper parameter include the depth of a tree in heterogeneous mixture learning and the depth of a layer in a neural network.

Furthermore, information determining preprocessing applied to input data before input to an AI engine may be determined. When a prediction model is generated by an AI engine, learning precision can be improved by performing scale conversion or the like instead of directly using input data. Then, such preprocessing to be applied to input data is defined by the item definition information 12. In addition, for example, processing of extracting only part of input data as a processing target, or the like is defined as preprocessing. In addition, for example, processing of converting an input data format into a predetermined format determined for each AI engine (a format interpretable by the AI engine) is also defined as preprocessing.

Note that the algorithm definition information 14 may include a program module itself providing preprocessing or may include identification information (such as a function name) and setting information (such as an argument) for calling a program providing the preprocessing. In the latter case, various types of preprocessing are previously provided in the generation unit 102. Then, by determining identification information of preprocessing to be used and setting information of the preprocessing in the algorithm definition information 14, desired preprocessing is executed by the generation unit 102.

The number of prediction models (prediction targets) generated by analysis using one piece of template information 10 is not limited to one. For example, it is assumed that template information 10 for predicting unit sales is prepared for each store and each product. In this case, a prediction target is unit sales for each combination of “store, product.”. Accordingly, a prediction model is generated for each store and each product by using the template information 10.

For example, it is assumed as a simple example that there are three types of products being products G1 to G3, and there are two stores being stores S1 and S2. In this case, there are six prediction targets, and therefore six prediction models are generated. Specifically, a prediction model of unit sales for each of the products G1 to A3 is generated for each of the stores S1 and S2.

A prediction model generated by analysis using one piece of template information 10 is predefined by the algorithm definition information 14. Specifically, an objective variable is predefined in a form such as “sales for each store and each product” in template information 10 for generating a prediction model predicting unit sales for each store and each product. Therefore, a prediction model is generated by the generation unit 102 for each store and each product.

It is preferable that the generation unit 102 perform not only generation of a prediction model but also evaluation (verification) of precision of the prediction model. In this case, for example, the generation unit 102 divides input data into learning data and verification data. Then, the generation unit 102 performs generation of a prediction model (learning of a model) by using the learning data and performs verification of the prediction model by using the verification data. In addition, for example, the generation unit 102 may perform so-called cross validation. Thus, an existing technology can be used as a specific method for dividing input data and performing generation and evaluation of a model.

The generation unit 102 may further execute prediction using a prediction model in addition to performing generation and verification of the prediction model. In this case, for example, the generation unit 102 divides input data into test data used for prediction and other data (data used for learning and verification). Then, after performing generation and verification of a prediction model with the latter, the generation unit 102 executes prediction by using the test data. Note that an existing technology can be used as a specific method for thus dividing input data and performing generation and verification of a prediction model, and prediction.

Note that the information processing apparatus 100 does not necessarily need to execute prediction immediately after generating a prediction model. For example, a user first performs generation and verification of a prediction model by using the information processing apparatus 100. The generated prediction model is stored into a storage apparatus accessible from the information processing apparatus 100. Subsequently, when there is a need for prediction, the user performs prediction by using the previously generated prediction model.

The method for dividing input data may be determined in a fixed manner regardless of template information 10, may be determined by template information 10, or may be specified by a user. For example, when input data are divided by periods, the user specifies a period of use of input data for each piece of learning data, verification data, and test data.

Note that prediction using a prediction model does not necessarily be executed by the information processing apparatus 100. For example, as described above, when the information processing apparatus 100 is configured with a front-end server 30 and a back-end server 40, prediction using a prediction model may be executed by a user terminal 20. In this case, a prediction model generated by the information processing apparatus 100 is stored into a storage apparatus accessible from the user terminal 20.

The generation unit 102 according to the present example embodiment can use a prediction result by a prediction model as one of input data items of an optimization model. Thus, an optimization model 80 can be generated based on various analysis contents, and therefore a more sophisticated optimization model 80 can be generated.

While the example embodiments of the present invention have been described above with reference to the drawings, the example embodiments are exemplifications of the present invention, and various configurations other than those described above may be employed.

For example, a configuration of customizing a template 5 itself used in the aforementioned example embodiments may be employed. For example, a layout of an imported data file may be changed. Furthermore, by adding and changing an objective function and a constraint included in a template 5, another template 5 may be prepared. Furthermore, selection of an AI engine for performing optimization or intention learning, a method for specifying periods in which optimization and intention learning are executed, and the like may be changed.

While the present invention has been described above with reference to the example embodiments, the present invention is not limited to the aforementioned example embodiments and examples thereof. Various changes and modifications that may be understood by a person skilled in the art may be made to the configurations and details of the present invention, within the scope of the present invention.

Note that when information about a user is acquired and used in the present invention, the acquisition and the use are assumed to be performed legally.

The whole or part of the example embodiments disclosed above may also be described as, but not limited to, the following supplementary notes.
1. An information processing apparatus including
   a generation unit that generates an optimization model by using a template defining an objective function and a constraint that are indicators of an optimization problem, wherein
   the template includes item definition information determining data items input to the objective function and the constraint, and algorithm definition information defining an algorithm for the objective function and the constraint.
2. The information processing apparatus according to 1., further including
   an acceptance unit that accepts specification of a parameter for changing at least part of the indicators of the optimization problem, wherein
   the generation unit generates the optimization model by using the template changed by using the accepted parameter.
3. The information processing apparatus according to 1. or 2., wherein
   the generation unit inputs data of the data item defined by the item definition information and generates the optimization model by optimizing the input data by using the template.
4. The information processing apparatus according to any one of 1. to 3., wherein
   the template includes view definition information determining a display form of information about an analysis result by the optimization model.
5. The information processing apparatus according to any one of 1. to 4., wherein
   the template is provided for each item to be optimized by the optimization model.
6. The information processing apparatus according to any one of 1. to 5., wherein
   a group of a plurality of the indicators is provided for each purpose of optimization in the template.
7. The information processing apparatus according to any one of 1. to 6., wherein
   the generation unit uses a prediction result by a prediction model as one of the data items of the input data of the optimization model.
8. The information processing apparatus according to any one of 1. to 7., wherein
   the template includes a weight indicating an intention of a user for each indicator of the optimization problem.
9. The information processing apparatus according to 8., wherein
   the algorithm definition information includes an intention learning algorithm for estimating the weight, and
   the generation unit computes the weight by using the intention learning algorithm and generates the optimization model by reflecting the weight in the template.
10. An information processing method including, by an information processing apparatus,
   generating an optimization model by using a template defining an objective function and a constraint that are indicators of an optimization problem, wherein
   the template includes item definition information determining data items input to the objective function and the constraint, and algorithm definition information defining an algorithm for the objective function and the constraint.
11. The information processing method according to 10., further including, by the information processing apparatus,
   accepting specification of a parameter for changing at least part of the indicators of the optimization problem, and
   generating the optimization model by using the template changed by using the accepted parameter.
12. The information processing method according to 10. or 11., further including, by the information processing apparatus,
   inputting data of the data item defined by the item definition information, and generating the optimization model by optimizing the input data by using the template.
13. The information processing method according to any one of 10. to 12., wherein
   the template includes view definition information determining a display form of information about an analysis result by the optimization model.
14. The information processing method according to any one of 10. to 13., wherein
   the template is provided for each item to be optimized by the optimization model.
15. The information processing method according to any one of 10. to 14., wherein
   a group of a plurality of the indicators is provided for each purpose of optimization in the template.
16. The information processing method according to any one of 10. to 15., further including, by the information processing apparatus,
   using a prediction result by a prediction model as one of the data items of the input data of the optimization model when generating the optimization model.
17. The information processing method according to any one of 10. to 16., wherein
   the template includes a weight indicating an intention of a user for each indicator of the optimization problem.
18. The information processing method according to 17., wherein
   the algorithm definition information includes an intention learning algorithm for estimating the weight, and
   the information processing method further includes, by the information processing apparatus,
   computing the weight by using the intention learning algorithm, and generating the optimization model by reflecting the weight in the template.
19. A program causing a computer to execute
   a procedure for generating an optimization model by using a template defining an objective function and a constraint that are indicators of an optimization problem, wherein
   the template includes item definition information determining data items input to the objective function and the constraint, and algorithm definition information defining an algorithm for the objective function and the constraint.
20. The program according to 19., further causing the computer to execute:
   a procedure for accepting specification of a parameter for changing at least part of the indicators of the optimization problem; and
   a procedure for generating the optimization model by using the template changed by using the accepted parameter.
21. The program according to 19. or 20., further causing the computer to execute
   a procedure for inputting data of the data item defined by the item definition information and generating the optimization model by optimizing the input data by using the template.
22. The program according to any one of 19. to 21., wherein
   the template includes view definition information determining a display form of information about an analysis result by the optimization model.
23. The program according to any one of 19. to 22., wherein
   the template is provided for each item to be optimized by the optimization model.
24. The program according to any one of 19. to 23., wherein
   a group of a plurality of the indicators is provided for each purpose of optimization in the template.
25. The program according to any one of 19. to 24., further causing the computer to execute
   a procedure for using a prediction result by a prediction model as one of the data items of the input data of the optimization model.
26. The program according to any one of 19. to 25., wherein
   the template includes a weight indicating an intention of a user for each indicator of the optimization problem.
27. The program according to 26., wherein
   the algorithm definition information includes an intention learning algorithm for estimating the weight, and
   the program further causes the computer to execute a procedure for computing the weight by using the intention learning algorithm, and generating the optimization model by reflecting the weight in the template.

This application claims priority based on Japanese Patent Application No. 2021-070593 filed on Apr. 19, 2021, the disclosure of which is hereby incorporated by reference thereto in its entirety.

### REFERENCE SIGNS LIST

1 Information processing system
5 Template
10 Template information
12 Item definition information
14 Algorithm definition information
16 View definition information
20 User terminal
30 Front-end server
30 End server
40 Back-end server
60 Template information storage apparatus
80 Optimization model
100 Information processing apparatus
102 Generation unit
104 Acceptance unit
200 Indicator list screen
202 Optimization period weeks specification field
204 Optimization period start date specification field
206 Learning period start date specification field
207 Learning period finish date specification field
208 Verification period start date specification field
209 Verification period finish date specification field
210 Objective function list
220 Constraint list
230 Setting button
240 Execution button
242 Abort button
300 Parameter setting screen
310 Specification method description field
320 Parameter specification field
330 Weight specification field
340 Registration button
342 Button
400 Optimization execution screen
402 Template list
404 Row
406 Optimization execution button
408 Intention learning execution button
500 Import screen
502 File specification list
504 File selection button
506 Import execution button
510 Shift record data
512 Vacation/work preference data
514 Employee master
600 Shift schedule
610 Vacation/work request achievement status
1000 Computer
1010 Bus
1020 Processor
1030 Memory
1040 Storage device
1050 Input-output interface
1060 Network interface

What is claimed is:

1. An information processing apparatus comprising:
at least one memory configured to store instructions; and
at least one processor configured to execute the instructions to
generate an optimization model by using a template defining an objective function and a constraint that are indicators of an optimization problem, wherein
the template includes item definition information determining data items input to the objective function and the constraint, and algorithm definition information defining an algorithm for the objective function and the constraint.

2. The information processing apparatus according to claim 1, wherein the at least one processor is further configured to execute the instructions to:
accept specification of a parameter for changing at least part of the indicators of the optimization problem; and
generate the optimization model by using the template changed by using the accepted parameter.

3. The information processing apparatus according to claim 1, wherein the at least one processor is further configured to execute the instructions to
input data of the data item defined by the item definition information and generate the optimization model by optimizing the input data by using the template.

4. The information processing apparatus according to claim 1, wherein
the template includes view definition information determining a display form of information about an analysis result by the optimization model.

5. The information processing apparatus according to claim 1, wherein
the template is provided for each item to be optimized by the optimization model.

6. The information processing apparatus according to claim 1, wherein
a group of a plurality of the indicators is provided for each purpose of optimization in the template.

7. The information processing apparatus according to claim 1, wherein the at least one processor is further configured to execute the instructions to
use a prediction result by a prediction model as one of the data items of the input data of the optimization model.

8. The information processing apparatus according to claim 1, wherein
the template includes a weight indicating an intention of a user for each indicator of the optimization problem.

9. The information processing apparatus according to claim 8, wherein
the algorithm definition information includes an intention learning algorithm for estimating the weight, and the at least one processor is further configured to execute the instructions to
compute the weight by using the intention learning algorithm and generate the optimization model by reflecting the weight in the template.

10. An information processing method comprising, by an information processing apparatus,
generating an optimization model by using a template defining an objective function and a constraint that are indicators of an optimization problem, wherein
the template includes item definition information determining data items input to the objective function and the constraint, and algorithm definition information defining an algorithm for the objective function and the constraint.

11. The information processing method according to claim 10, further comprising, by the information processing apparatus,
accepting specification of a parameter for changing at least part of the indicators of the optimization problem, and
generating the optimization model by using the template changed by using the accepted parameter.

12. The information processing method according to claim 10, further comprising, by the information processing apparatus,
inputting data of the data item defined by the item definition information, and generating the optimization model by optimizing the input data by using the template.

13. The information processing method according to claim 10, wherein
the template includes view definition information determining a display form of information about an analysis result by the optimization model.

14. The information processing method according to claim 10, wherein
the template is provided for each item to be optimized by the optimization model.

15. The information processing method according to claim 10, wherein
a group of a plurality of the indicators is provided for each purpose of optimization in the template.

16. The information processing method according to claim 10, further comprising, by the information processing apparatus,
using a prediction result by a prediction model as one of the data items of the input data of the optimization model when generating the optimization model.

17. The information processing method according to claim 10, wherein
the template includes a weight indicating an intention of a user for each indicator of the optimization problem.

18. The information processing method according to claim 17, wherein
the algorithm definition information includes an intention learning algorithm for estimating the weight, and
the information processing method further comprises, by the information processing apparatus,
computing the weight by using the intention learning algorithm, and generating the optimization model by reflecting the weight in the template.

19. A non-transitory computer-readable storage medium storing a program causing a computer to execute
a procedure for generating an optimization model by using a template defining an objective function and a constraint that are indicators of an optimization problem, wherein
the template includes item definition information determining data items input to the objective function and the constraint, and algorithm definition information defining an algorithm for the objective function and the constraint.

20.-25. (canceled)

26. The non-transitory computer-readable storage medium according to claim 19, wherein
the template includes a weight indicating an intention of a user for each indicator of the optimization problem,
the algorithm definition information includes an intention learning algorithm for estimating the weight, and
the program further causes the computer to execute a procedure for computing the weight by using the intention learning algorithm, and generating the optimization model by reflecting the weight in the template.

27. (canceled)
